(19) United States
(12) Patent Application Publication
(10) Pub. No.: US 2021/0222693 A1
(43) Pub. Date: Jul. 22, 2021

(54) ORBITER VACUUM PUMP CAPABLE OF DRY-RUNNING

(71) Applicant: NIDEC GPM GmbH, Auengrund OT Merbelsrod (DE)

(72) Inventors: Conrad Nickel, Troistedt (DE); Jakob Schnitzer, Hildburghausen (DE); Franz Pawellek, Lautertal (DE)

(21) Appl. No.: 17/126,614

(22) Filed: Dec. 18, 2020

(30) Foreign Application Priority Data
Jan. 21, 2020 (DE) 10 2020 101 312.4

(51) Int. Cl. F04C 25/02; F04C 29/00; F04C 29/02

(52) U.S. Cl. CPC F04C 25/02; F04C 29/0057; F04C 2240/30; F04C 2240/50; F04C 29/02

(57) ABSTRACT

The present invention relates to a dry-running, oil-free orbiter vacuum pump with an improved bearing arrangement consisting of a material pairing capable of dry-running A pivot bearing with a bearing cavity open towards the pump chamber for receiving a pivot head of a blocking slide is arranged inside the pump housing. The orbiter vacuum pump capable of dry-running is characterized in particular in that at least one sliding surface of the pivot bearing allocated to the bearing cavity or to the pivot head is made of a composite material including a solid lubricant.

### CLAIM FOR PRIORITY

This application claims the benefit of priority of German Application No. 10 2020 101 312.4, filed 21 Jan.2020, which is hereby incorporated by reference in its entirety.

### TECHNICAL FIELD

The present invention relates to a dry-running, oil-free orbiter vacuum pump with an improved bearing arrangement consisting of a material pairing capable of dry-running

### BACKGROUND

Dry-running vacuum pumps serve to evacuate gaseous media, such as e.g. for the purpose of generating a vacuum in a braking force booster. In the automotive sector, further applications of dry-running vacuum pumps include the pneumatic adjustment of exhaust gas recirculation valves, exhaust flaps, guide vanes on turbochargers having a variable turbine geometry, and of a bypass for charging pressure regulation with a waste gate, and include the actuation of a central locking system, or for opening and closing headlight covers. In plant construction, dry-running vacuum pumps can serve in general to produce negative pressure in electro-pneumatic valves or pneumatic actuators.

Rotary displacement pumps, such as e.g. vane pumps or rotary vane pumps, are predominantly known for this purpose in the prior art and are very widely used.

Some pumps require the provision of a lubricating film between the rotating and stationary pump components in order to ensure a sufficiently gas-tight seal as well as low frictional wear on contact surfaces. The requirement for a lubricating film in a vacuum pump gives rise to problems in terms of the temperature-dependent viscosity of the lubricant and the contamination caused by absorption of particles from the discharged air. These disadvantages are brought to bear under fluctuating ambient conditions of a mobile application and in particular to an increased extent in an installation in an engine compartment of a vehicle. Moreover, such pumps must always be connected to a lubricant supply or integrated into a lubricant-carrying system.

In order to avoid the aforementioned problem, dry-running vacuum pumps are known in the prior art. For the bearing arrangements of movable pump parts in such dry-running vacuum pumps, lubrication is provided for the service life of the pump. Lubrication for the service life is provided once during production of the pump in the form of a sealed lubricant filling of a viscous lubricant or a solid lubricant, such as in particular graphite, which is introduced in the corresponding bearings.

DE 10 2015 010 846 A1 by the same applicant describes an orbiter vacuum pump, of which the design of the pump assembly is similar to the design of the pump assembly of the present invention. However, there is a need to optimize bearing arrangements of such a dry-running orbiter vacuum pump.

### SUMMARY/OVERVIEW

Consequently, it is an object of the invention to optimize a pivot bearing, which is specific for the pump assembly of an orbiter type, such that during a dry-running operation as a vacuum pump, friction loss and wear of the pivot bearing are reduced.

The invention is achieved by the features of the claims. The inventive, dry-running orbiter vacuum pump is characterized in particular in that at least one sliding surface of the pivot bearing allocated to the bearing cavity or to the pivot head is made of a composite material including a solid lubricant.

Therefore, for the first time the invention provides a specific material pairing relating to the sliding surfaces of a pivot bearing for a dry-running operation in a vacuum pump.

In the most general form of the invention, provision is made that a radial sliding surface of one of the opposing bearing parts which are in sliding contact (i.e. the pivot head), the bearing cavity or a sliding bearing sleeve arranged therebetween, are made from a self-lubricating material, in which a solid lubricant is incorporated preferably in a homogeneously distributed manner A corresponding composite material including a solid lubricant ensures that, in particular in comparison with a lubricant filling, a long-lasting dry-running capability can be provided in a vacuum operation. In comparison with a conventional material pairing of the bearing parts, such as e.g.: metal/metal, metal/synthetic material or synthetic material/synthetic material with a lubricant filling, the use of the composite material including a solid lubricant achieves a lower level of friction and a higher level of wear resistance in the long term. The higher level of wear resistance is also achieved when only one of the bearing parts consisting of the composite material including solid lubricant is provided and an opposing bearing part is made of a metal or synthetic material which has a higher material hardness than the composite material.

Embedding of the solid lubricant as a component of a material matrix of the composite material is suitable particularly for long-lasting lubrication in the use of a dry-running vacuum pump because the solid lubricant is not abraded to an exhaustive extent in spite of the friction and wear and is not removed by negative pressure. Therefore, it is possible to provide maintenance-free lubrication over the service life of the vacuum pump.

DE 10 2016 211 260 A1 discloses a use of solid lubricants in different types of vacuum pumps, such as e.g. screw pumps, claw pumps or Roots pumps. However, for this purpose only an emergency operation coating based on molybdenum disulfide is provided which is applied on the pump housing.

U.S. Pat. No. 5,493,953 A likewise describes an arrangement of a cylinder and piston for a compressor or a vacuum pump, wherein provision is made that a cylinder guideway is coated with a film consisting of molybdenum disulfide.

DE 37 11 986 A1 relates to a spiral-type compressor, in which a spiral element consists of a metal and has a coating layer consisting of resin. The resin includes a mixture of graphite powder and molybdenum disulfide as a solid lubricant. The disclosure does not relate to the aspect for optimizing a pivot bearing during vacuum operation.

The production of a coating and the provision of an additional coating material considerably increase the manufacturing outlay and costs for series production of vacuum pumps. Furthermore, after wear or after the appearance of a flaw or damage in a coating, the operating behavior of a pivot bearing can deteriorate suddenly.

A Roots pump for generating a high vacuum is known from DE 39 065 84 A1. In this case, a coating of gearwheels with MoS₂ is proposed. Alternatively, provision is made that the gearwheel material itself is used as a lubricant reservoir, wherein reference is made to a molybdenum-copper composite which provides a metallic porous main body which is impregnated with the solid lubricant.

DE 26 00 972 A1 describes a multicellular compressor for a compression and vacuum operation, of which the separating slides consist of materials which are capable of dry-running and are fiber-reinforced. Molybdenum disulfide is defined, inter alia, as a dry-running material.

EP 2 905 468 B1 discloses an oil-free compressor, the piston of which can comprise circumferential support rings which include a solid lubricant.

Finally, DE 103 92 502 T5 discloses a piston pump for compressing air, in which in one variant at least a part of the piston sliding on a cylinder inner wall consists of a self-lubricating material. An example relating to the use of a composite material consisting of an organic solid lubricant, such as Teflon or PTFE, and an inorganic solid lubricant, such as molybdenum sulfide, is provided.

In summary, said prior art documents provide merely either a coating of a housing part or the production of a piston part, such as a support ring or a separating slide in the application for a compressor, and without further details relating to a suitable composite material in terms of optimizing a solid lubrication during the vacuum operation. Furthermore, said disclosures do not relate to the aspect of optimizing a pivot bearing or other bearing parts during a vacuum operation.

Therefore, with regard to the problem, even after acknowledging said prior art there was still a need to optimize bearing arrangements of a dry-running orbiter vacuum pump.

Advantageous developments of the invention are provided in the dependent claims.

According to one aspect of the invention, the composite material can be based on a polymer matrix, and the composite material can include at least one of the solid lubricants molybdenum disulfide and/or graphite as a filler in a proportion of 10% to 30% of the weight. By reason of the defined proportion range of the solid lubricant as a filler in a synthetic material as an embedding matrix, the following advantages are achieved:

On the one hand, molybdenum disulfide (MoS₂) or graphite can be admixed as a filler in synthetic materials, whereby it can be incorporated in a homogeneously distributed manner in a suitable polymer matrix. A composite material consisting of a polymer matrix and the defined proportion range of molybdenum disulfide as a filler has sufficient solidity to form a bearing part or a pump component and can be produced economically. The relevant bearing parts or pump components can be produced easily by means of an injection-moulding method, without the requirement for any subsequent processing, such as in particular coating, or incorporating a solid lubricant into the surface or impregnating the surface with a solid lubricant.

On the other hand, a solid lubricant which is incorporated as a filler in a polymer matrix, and preferably is present in a homogeneous distribution on a component surface provides excellent coefficients of friction for the application on bearing parts in a dry-running vacuum pump. In particular, molybdenum disulfide (MoS₂) is highly suitable as a solid lubricant for the application in a dry-running vacuum pump.

The solid lubricant graphite requires water or moisture for establishing a low-friction layer between a moving and a static pump part. The paucity of water in friction pairings in the vacuum leads to an increase in the coefficient of friction. In comparison with graphite, molybdenum disulfide demonstrates contrary behavior relating to the coefficient of friction. In contrast to the behavior of the coefficient of friction of graphite which increases when there is a paucity of water in the vacuum, the coefficient of friction of molybdenum disulfide even decreases when there is a paucity of water in the vacuum

According to one aspect of the invention, the polymer matrix can consist of a thermoplastic, in particular Polimid PA 6. In terms of application, this synthetic material has the best properties relating to solidity and friction.

According to one aspect of the invention, the polymer matrix can also consist of the thermoplastic polyamide PA 6.6 or nylon. This synthetic material has good properties relating to solidity and friction at economically viable material costs.

According to one aspect of the invention, the polymer matrix can consist of a thermosetting polymer, preferably a phenolic plastic. This embodiment represents an alternative compromise in terms of the properties relating to solidity and friction and the economic viability of the material costs.

According to one aspect of the invention, the polymer matrix can include, in a proportion of 20% to 50% of the polymer matrix, glass fibers or cullet as a filler. This embodiment represents an optimization in terms of the properties relating to solidity and friction and the economic viability of the material costs.

According to one aspect of the invention, the entire pump housing or at least a portion of the pump housing surrounding the bearing cavity of the pivot bearing can be made of the composite material including the solid lubricant. In this embodiment, the inventive material pairing on a sliding surface of the pivot bearing is produced already by the formation of the bearing cavity in the pump housing, without the requirement for a further post-processing step or a further modified bearing part or pump component.

According to one aspect of the invention, the pivot bearing can further include a sliding bearing bushing with a C-shaped cross-section with respect to the pivot axis, and the sliding bearing bushing can be made of the composite material including the solid lubricant. In this embodiment, the sliding bearing sleeve consisting of the composite material including the solid lubricant takes on the function of a sliding surface, comparable with a cartilage in a knee joint. As a result, the pump housing can optionally also be made of any conventional material, without having to seriously modify existing series production.

According to one aspect of the invention, the blocking slide including the pivot head can be made of a stainless steel as a bent sheet-metal part. In this embodiment, an inventive material pairing must be provided for a sliding surface of the bearing cavity or a sliding sleeve. However, it is thus possible to manufacture the pivot head and the elongate part or blade of the blocking slide together from a strip-like material in a cost-optimized manner.

According to one aspect of the invention, the blocking slide including the pivot head can be made of a stainless sintered steel as a sintered part. In this embodiment, an inventive material pairing must be provided for a sliding surface of the bearing cavity or a sliding sleeve. However, it is thus possible to produce the blocking slide in a very robust and dimensionally stable manner.

According to one aspect of the invention, the blocking slide can be made of a stainless steel; and the pivot head can be made of the composite material including the solid lubricant. In this embodiment, an inventive material pairing can be provided for the sliding surface of the pivot head. The composite material can be integrally formed on the elongate part or the blade of the blocking slide in a cost-effective manner by means of an injection-moulding technique, such as e.g. over-moulding.

According to one aspect of the invention, the blocking slide including the pivot head can be made of the composite material including the solid lubricant. In this embodiment, an inventive material pairing can likewise be provided for the sliding surface of the pivot head, wherein the blocking slide is made of the composite material in a simple manner completely by means of injection-moulding. The advantages relating to the reduction in friction and wear can be achieved at the same time at the sliding contacts with the guide slot in the orbiter eccentric piston.

According to one aspect of the invention, the entire pump housing or at least a portion of the pump housing surrounding the bearing cavity of the pivot bearing can be made of a metal. In this embodiment, an inventive material pairing must be provided for the sliding surface of the pivot head. However, the pump housing can optionally also be made of a conventional metallic material, without having to seriously modify any existing series production.

According to one aspect of the invention, the pivot bearing can further include a sliding bearing bushing with a C-shaped cross-section with respect to the pivot axis, and the sliding bearing bushing can be made of a stainless steel. In this embodiment, an inventive material pairing must likewise be provided for the sliding surface of the pivot head. For this purpose, the sliding sleeve can be provided as a cost-effective bent sheet-metal part and the pump housing can be made of any conventional material.

### BRIEF DESCRIPTION OF THE FIGURES

The invention will be explained hereinafter with reference to the accompanying drawing with the aid of a preferred embodiment of an orbiter vacuum pump. In the drawing:

FIG. 1 shows a cross-section of the pump chamber of an orbiter vacuum pump according to one embodiment of the invention;

FIG. 2 shows an axial cross-section through the cutting line A-A of the orbiter vacuum pump in FIG. 1.

### DETAILED DESCRIPTION

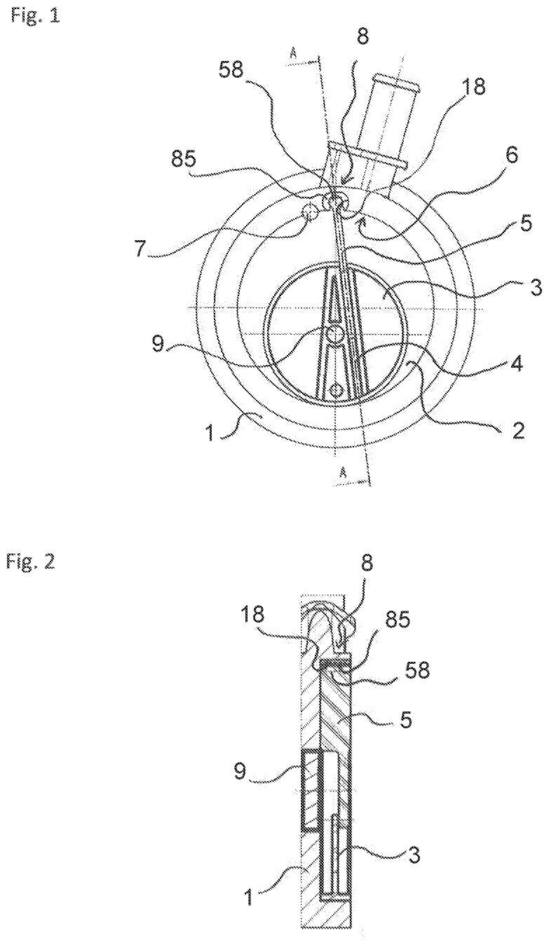

As shown in FIGS. 1 and 2, the orbiter vacuum pump is formed from a pump housing 1 which comprises a pump chamber 2 which is closed by a pump cover and has a cylindrical chamber wall. In the pump housing 1, a shaft is arranged in such a manner as to be rotatably mounted by means of a shaft bearing (not illustrated). An eccentric disk 9 with an eccentrically arranged crankpin is fixed on the shaft. The eccentric disk 9 engages with the crankpin in the center point of a cylindrical orbiter eccentric piston 3 designed as a piston drum.

The eccentric disk 9 performs a circular movement of the orbiter eccentric piston 3 through the pump chamber 2, wherein circumferential sliding contact of the orbiter eccentric piston 3 with the cylindrical chamber wall is maintained. Arranged in the orbiter eccentric piston 3 is a guide slot 4 which slidably receives a blocking slide 5. The blocking slide 5 is pivotably mounted in the chamber wall at a free end and extends through the pump chamber 2 to the orbiter eccentric piston 3. For this purpose, a pivot bearing 8 which is described more precisely hereinafter is arranged between an inlet opening 6 and an outlet opening 7 in the chamber wall. In dependence upon the position of the orbiter eccentric piston 3 on the circular movement in the pump chamber 2, a portion of the blocking slide 5 located opposite the pivotably mounted end slides in and out in the guide slot 4. The pump chamber 2 is divided, either side of the blocking slide 5, into two volumes, of which one communicates with the inlet opening 6 and one communicates with the outlet opening 7.

The volumes on each side of the blocking slide 5 vary with the circumferential sliding contact between the orbiter eccentric piston 3 and the cylindrical chamber wall in equal proportions oppositely to one another such that a cyclical displacement procedure is completed within one revolution of the shaft or a circular movement of the orbiter eccentric piston 3. During the circular movement of the orbiter eccentric piston 3, a torque required for the displacement procedure rises during the increase in the volume communicating with the inlet 6 and falls abruptly when a maximum volume is reached. The illustration in FIG. 1 shows a position of the orbiter eccentric piston 3 approximately halfway prior to a top dead center, in which the volume of the pump chamber 2 communicating with the inlet 6 reaches an almost maximum volume and the content thereof is thereafter pushed out of the outlet 7. The shaft is driven preferably by an electric motor, not illustrated.

By means of the aforementioned pivot bearing 8, the blocking slide 5 which slides in and out in the guide slot 4 during the circular movement of the orbiter eccentric piston 3 simultaneously performs a pivoting movement. The pivot bearing 8 is formed substantially by means of two sliding surfaces which are provided on the one hand on a bearing cavity 18 open towards the pump chamber 2, and on the other hand on a roller-shaped pivot head 58 of the blocking slide 5. The bearing cavity 18 is formed in the pump housing. The pivot head 58 is formed at a free end of the blocking slide 5. At least one of two sliding surfaces on the side of the bearing cavity 18 or of the pivot head 58 consists of the composite material which is defined hereinafter and includes a solid lubricant.

Furthermore, in one structural embodiment of the invention illustrated in FIG. 1, the pivot bearing 8 has a sliding sleeve 85 with a C-shaped cross-section which is arranged about a pivot point of the pivot bearing 8 between the pivot head 58 and the bearing cavity 18. The sliding sleeve 85 consists of the composite material including the solid lubricant. Depending upon the fit, the radially inner surface of the sliding sleeve 85 forms or replaces the sliding surface of the bearing cavity 18, or the radially outer surface of the sliding sleeve 85 forms or replaces the sliding surface of the pivot head 58. It is likewise possible to have a variant, in which the two radial surfaces of the sliding sleeve 85 simultaneously form or replace both sliding surfaces of the pivot bearing 8.

In one structural embodiment of the invention which is not illustrated, the pivot joint 8 does not have a sliding sleeve 85. The pump housing 1 and thus the sliding surface of the bearing cavity 18 consist of the composite material including the solid lubricant. In an alternative variant of this structural embodiment, only a portion of the pump housing 1, in which the bearing cavity 18 is formed, consists of the composite material including the solid lubricant.

In one not-illustrated, further structural embodiment of the invention, the pivot joint 8 does not have a sliding sleeve 85. The pivot head 58 and thus the sliding surface on the side of the blocking slide 5 consist of the composite material including the solid lubricant. The composite material is integrally formed as a roller-shaped cast body on the free end of the blocking slide 5 by means of over-moulding. In an alternative variant of this structural embodiment, the blocking slide 5 including the pivot head 58 consists completely of the composite material including the solid lubricant.

Furthermore, elements of the aforementioned structural embodiments can be combined with one another, wherein in particular as an alternative embodiment, provision can be made that both the pump housing 1 and the pivot head 58 or the sliding sleeve 85 and the pivot head 58 are made of the composite material including the solid lubricant.

The composite material which includes the solid lubricant and from which the pump housing 1, the sliding sleeve 85 or the pivot head 58 of the aforementioned structural embodiments is made will be defined in greater detail hereinafter.

The composite material is produced by means of a material melt, in which a solid lubricant, such as molybdenum disulfide or graphite as a filler is admixed and homogeneously mixed. The material melt which, in the solidified state, serves as a matrix for incorporating the solid lubricant is preferably a synthetic material on the basis of a polyamide or phenolic plastic having a high degree of solidity.

In the preferred first embodiment of the invention illustrated in FIG. 1 and relating to a composite material having a particularly high level of wear resistance and low coefficient of friction, a polymer matrix of the composite material consists of polyamide designated as PA 6.0 or Polimid, in which pure molybdenum disulfide as a filler with a preferred weight proportion of 15% relating to the weight of the resulting composite material is admixed in a homogeneously distributed manner The composite material is processed by means of an injection-moulding process to produce a corresponding bearing part of the pivot bearing 8.

After tests performed by the inventors, the preferred composite material, which includes a 15% weight proportion of molybdenum disulfide as a filler in a polymer matrix, which consists of the thermoplastic Polimid PA 6, demonstrated the best properties relating to the wear resistance and a low-friction operation.

The inventors found out that the behavior of the coefficient of friction of molybdenum disulfide gives rise to a considerable advantage for the application of solid lubrication in a dry-running vacuum pump. Furthermore, the inventors found out that this advantage is also retained and can be provided permanently if the molybdenum disulfide as a filler is homogeneously mixed in a synthetic material melt with the objective that a moving bearing part of the pivot bearing 8 consisting of the resulting composite material permanently ensures continuous solid lubrication on the corresponding sliding surface.

The molybdenum disulfide which is admixed with the synthetic material-based composite material and is homogeneously distributed therein is provided in powder form and consists of particles in the form of so-called flakes having a predominant size distribution of 1 μm or several μm up to 100 μm in length. When viewed under magnification, the molybdenum sulfide flakes consist of a plurality of alternating atomic layers of molybdenum atoms and sulphur atoms, i.e. a sandwich structure consisting of two-dimensional, so-called basal planes which slide against one another and can be displaced, resulting in the lubricating effect of the solid.

Since the particles of the molybdenum disulfide are embedded in the polymer matrix of the Polimid, they are not transported away by the conveyed gas stream in the sense of a loosely distributed solid lubricant. Furthermore, the solid lubrication is not subject to consumption by a wear-induced superficial material abrasion. Since the particles of the molybdenum disulfide as a filler are distributed homogeneously in the polymer matrix of the Polimid, a concentration of the solid lubricant which is provided on the sliding surfaces of the pivot bearing 8 does not change even after wear occurs. In contrast to a superficial lubrication or coating, this applies even if long-term material abrasion of the composite material should occur partially or uniformly on the respective sliding surface of the pivot bearing 8 as a result of the friction.

Further embodiments of the invention relating to the composite material as well as alternative variants to the various embodiments will be described hereinafter.

In one variant of the first embodiment, the polymer matrix consisting of Polimid PA 6 includes a weight proportion of 10% molybdenum sulfide as a filler. In another variant of the first embodiment, the polymer matrix consisting of

Polimid PA 6 includes a weight proportion of 30% molybdenum sulfide as a filler. Within the scope of the invention, in further variants of the first embodiment, the polymer matrix consisting of Polimid PA 6 includes any weight proportion between 10% and 30% molybdenum sulfide as a filler.

In alternative variants of the first embodiment, the polymer matrix includes a further filler, namely a silicate filler in the form of glass fibers, cullet, glass spheres and/or hollow glass spheres. Such uniformly formed particles are mostly spherical or fibrous in configuration. For this purpose, it is possible to use very short glass fibers, of which the ratio of length to diameter is the factor of ca. 1 to 5, fragments having a corresponding ratio of length to diameter with the factor of ca. 1 or spherical particles consisting of micro-silicate. The fibers, similarly to the flakes of the molybdenum disulfide in powder form, have a dimension in the range of 1 μm to 100 μm. Said silicate fillers thus represent a preferred application-optimized selection over alternative fillers, such as talcum, chalk or silica dust.

In an alternative variant of the first embodiment, the polymer matrix consisting of Polimid PA 6 includes, in addition to the molybdenum disulfide, a weight proportion of 20% glass fibers or cullet as a silicate filler. In another alternative variant of the first embodiment, the polymer matrix consisting of

Polimid PA 6 includes, in addition to the molybdenum disulfide, a weight proportion of 50% glass fibers or cullet as a silicate filler. Within the scope of the invention, in further alternative variants of the first embodiment, the polymer matrix consisting of Polimid PA 6 includes, in addition to the molybdenum disulfide, any weight proportion between 20% and 50% glass fibers or cullet as a silicate filler.

In a second embodiment of the invention relating to the composite material, the polymer matrix consists of the thermoplastic polyamide PA 6.6 in which molybdenum disulfide is embedded as a filler. The polymer matrix consisting of polyamide PA 6.6 from the second embodiment includes a weight proportion of 15% molybdenum disulfide as a filler.

In one variant of this second embodiment, the polymer matrix consisting of polyamide PA 6.6 includes a weight proportion of 10% molybdenum sulfide as a filler. In another variant of the second embodiment, the polymer matrix consisting of polyamide PA 6.6 includes a weight proportion of 30% molybdenum sulfide as a filler. Within the scope of the invention, in further variants of the second embodiment, the polymer matrix consisting of polyamide PA 6.6 includes any weight proportion between 10% and 30% molybdenum sulfide as a filler.

In an alternative variant of the second embodiment, the polymer matrix consisting of polyamide PA 6.6 includes, in addition to the molybdenum disulfide, a weight proportion of 20% glass fibers or cullet as a silicate filler. In another alternative variant of the second embodiment, the polymer matrix consisting of polyamide PA 6.6 includes, in addition to the molybdenum disulfide, a weight proportion of 50% glass fibers or cullet as a silicate filler. Within the scope of the invention, in further alternative variants of the second embodiment, the polymer matrix consisting of polyamide PA 6.6 includes, in addition to the molybdenum disulfide, any weight proportion between 20% and 50% glass fibers or cullet as a silicate filler.

In a third alternative embodiment of the invention relating to the composite material, the polymer matrix consists of a phenolic plastic, in which molybdenum disulfide is embedded as a filler, The polymer matrix consisting of phenolic plastic from the third embodiment includes a weight proportion of 15% molybdenum disulfide as a filler.

In one variant of this third embodiment, the polymer matrix consisting of phenolic plastic includes a weight proportion of 10% molybdenum sulfide as a filler. In another variant of the third embodiment, the polymer matrix consisting of phenolic plastic includes a weight proportion of 30% molybdenum sulfide as a filler. Within the scope of the invention, in further variants of the third embodiment, the polymer matrix consisting of phenolic plastic includes any weight proportion between 10% and 30% molybdenum sulfide as a filler.

In an alternative variant of the third embodiment, the polymer matrix consisting of phenolic plastic includes, in addition to the molybdenum disulfide, a weight proportion of 20% glass fibers or cullet as a silicate filler. In another alternative variant of the third embodiment, the polymer matrix consisting of phenolic plastic includes, in addition to the molybdenum disulfide, a weight proportion of 50% glass fibers or cullet as a silicate filler. Within the scope of the invention, in further alternative variants of the third embodiment, the polymer matrix consisting of phenolic plastic includes, in addition to the molybdenum disulfide, any weight proportion between 20% and 50% glass fibers or cullet as a silicate filler.

In an alternative variant of the first to third embodiment relating to the composite material, it is also possible to use, instead of or in addition to the molybdenum disulfide, graphite as a solid lubricant in the polymer matrix.

An opposing sliding surface of the pivot bearing 8 which does not consist of the composite material can be provided from a material conventionally provided for the respective component, such as e.g. a metal.

In the preferred embodiment illustrated in FIG. 1 and relating to a friction pairing of the sliding surfaces of the pivot joint 8, the pump housing 1 or even the blocking slide 5 consist of a stainless sintered steel designated as Sint-C40 or Sint-D40 as a material for the pump housing 1. A steel which can be sintered provides a preferred processing technique for producing a housing part having a generally complex shape. After sintering, regions of a housing part, such as a cylindrical inner surface of the pump chamber 2 can be subsequently machined, whereby a high degree of dimensional stability can be ensured with respect to the movement sequence of the orbiter eccentric piston 3 and the resulting circumferential sealing gap. In one variant of this embodiment relating to the friction pairing, the pump housing 1 is made of a more cost-effective alloy in the form of a sintered steel designated as Sint-C32, Sint-C36 or even Sint-C39.

In another embodiment relating to the friction pairing of the sliding surfaces of the pivot joint 8, the pump housing 1 or even the blocking slide 5 consist of a stainless steel with the standard designation X17CrNi16-2 which provides a suitable, low-wear friction pairing at economically advantageous cost.

In alternative embodiments relating to a friction pairing of the sliding surfaces of the pivot joint 8, the pump housing consists of an aluminium alloy designated as AlSi₉Cu₃, or a ceramic consisting of aluminium oxide Al₂O₃.

It is necessary to take into account that the different embodiments relating to the composite material, just like the embodiments relating to a friction pairing of the sliding surfaces of the pivot joint 8 or components thereof can be interchanged and combined with the various aforementioned structural embodiments relating to the pivot bearing 8 and the elements or bearing parts thereof. That is to say in particular that any material-related aspects of the embodiments can be transferred to any structural aspect of the embodiments, according to which the core of the invention with its advantageous effects, as described above, is still achieved.

### LIST OF REFERENCE NUMERALS

1 pump housing
2 pump chamber
3 orbiter eccentric piston
4 guide slot
5 blocking slide
6 inlet
7 outlet
8 pivot bearing
9 eccentric disk with crankpin
18 bearing cavity
58 pivot head
85 sliding sleeve

What is claimed is:

1. A dry-running orbiter vacuum pump comprising:
a pump housing with a cylindrical pump chamber;
an orbiter eccentric piston with a guide slot and a cylindrical exterior surface, a cylindrical cross-section of the orbiter eccentric piston being smaller than a cylindrical cross-section of the pump chamber;
a shaft for driving the orbiter eccentric piston by means of an eccentric disk with a crankpin that meshes with the orbiter eccentric piston;
a blocking slide received in the guide slot of the orbiter eccentric piston, one end of the blocking slide being pivotably mounted at the pump housing between an inlet and an outlet; wherein
a pivot bearing with a bearing cavity open towards the pump chamber for receiving a pivot head of the blocking slide is arranged inside the pump housing;
wherein
at least one sliding surface of the pivot bearing allocated to the bearing cavity or to the pivot head is made of a composite material including a solid lubricant.

2. The dry-running orbiter vacuum pump according to claim 1, wherein the composite material is based on a polymer matrix, and the composite material includes at least one of the solid lubricants molybdenum disulfide and/or graphite as a filler in a proportion of 10% to 30% of the weight.

3. The dry-running orbiter vacuum pump according to claim 2, wherein the polymer matrix consists of a thermoplastic.

4. The dry-running orbiter vacuum pump according to claim 3, wherein the thermoplastic is Polimid PA 6.

5. The dry-running orbiter vacuum pump according to claim 3, wherein the thermoplastic is polyamide, preferably PA 6.6.

6. The dry-running orbiter vacuum pump according to claim 2, wherein the polymer matrix consists of a thermosetting polymer, preferably a phenolic plastic.

7. The dry-running orbiter vacuum pump according to claim 1, wherein the polymer matrix includes, in a proportion of 20% to 50% of the polymer matrix, glass fibers or cullet as a filler.

8. The dry-running orbiter vacuum pump according to claim 1, wherein the entire pump housing or at least a portion of the pump housing surrounding the bearing cavity of the pivot bearing is made of the composite material including the solid lubricant.

9. The dry-running orbiter vacuum pump according to claim 1, wherein the pivot bearing furthermore includes a sliding bearing bushing with a C-shaped cross-section with respect to the pivot axis, and the sliding bearing bushing is made of the composite material including the solid lubricant.

10. The dry-running orbiter vacuum pump according to claim 1, wherein the blocking slide including the pivot head is made of a stainless steel as a bent sheet-metal part.

11. The dry-running orbiter vacuum pump according to claim 1, wherein the blocking slide including the pivot head is made of a stainless sintered steel as a sintered part.

12. The dry-running orbiter vacuum pump according to claim 1, wherein the blocking slide is made of a stainless steel; and the pivot head is made of the composite material including the solid lubricant.

13. The dry-running orbiter vacuum pump according to claim 1, wherein the blocking slide including the pivot head is made of the composite material including the solid lubricant.

14. The dry-running orbiter vacuum pump according to claim 1, wherein the entire pump housing or at least a portion of the pump housing surrounding the bearing cavity of the pivot bearing is made of a metal.

15. The dry-running orbiter vacuum pump according to claim 1, wherein the pivot bearing furthermore includes a sliding bearing bushing with a C-shaped cross-section with respect to the pivot axis, and the sliding bearing bushing is made of a stainless steel.

16. The dry-running orbiter vacuum pump according to claim 14, wherein the blocking slide is made of a stainless steel; and the pivot head is made of the composite material including the solid lubricant.

17. The dry-running orbiter vacuum pump according to claim 14, wherein the blocking slide including the pivot head is made of the composite material including the solid lubricant.
